(19) United States
(12) Patent Application Publication
(10) Pub. No.: US 2005/0029399 A1
(43) Pub. Date: Feb. 10, 2005

(54) Fyling craft camera and sensor mechanism lift platform using tubular linear guides

(76) Inventors: Jerry D. Lowe, Woodland Park, CO (US); Brent K. DeRuyter, Simi Valley, CA (US)

Correspondence Address: BROWN RAYSMAN MILLSTEIN FELDER & STEINER, LLP, SUITE 711, 1880 CENTURY PARK EAST, LOS ANGELES, CA, 90067, US

(21) Appl. No.: 10/857,194

(22) Filed: May 28, 2004

Related U.S. Application Data
(63) Continuation-in-part of application No. 10/633,347, filed on Aug. 4, 2003.

(51) Int. Cl. B64C 1/20

(52) U.S. Cl. 244/118.1

(57) ABSTRACT

A system for extending and retracting an object, such as a camera or sensor, outside and inside a body, such as an aircraft, is disclosed. The system comprises a mounting structure and a linear guide connected to the mounting structure. A platform, to which the object is attached, is extended and retracted by a mechanism. The platform is extended and retracted, along the linear guide comprising one or more tubes to an outside and inside position with respect to the body. The mechanism may be electrically, hydraulically or pneumatically driven, for example. The mechanism may comprise a, linear motion screw. A clutch and brake apparatus may also be provided. Concealment doors may be opened upon extending the object, and closed upon retracting the object. The mounting structure is fitted into the shape of the body so as limit intrusion into the body.

### CROSS REFERENCE TO RELATED DOCUMENTS

This application is a continuation-in-part of U.S. patent application Ser. No. 10/633,347 filed Aug. 4, 2003.

### FIELD OF THE INVENTION

This invention relates to flying craft. More particularly, this invention relates to a mechanized lift platform that extends and retracts a device for capturing images, sounds and data, individually and collectively, from a flying craft, which may comprise, without limitation, an airplane, helicopter, blimp, hot air balloon or space craft. This invention has particular applicability to cameras and sensors installed in flying craft.

### BACKGROUND OF THE INVENTION

Flying craft are utilized to capture images, sounds and data, individually and collectively. Aerial image, sound and datum capturing devices include cameras and sensors. Aerial cameras and sensors are affixed to the flying craft either internally or externally. Internal cameras and sensors are mounted to the structure inside the body of the flying craft. Internally mounted cameras and sensors are able to capture images, sounds and data using a window, retractable door, or permanent opening in the flying craft. Internally mounted cameras and sensors have minimal, if any, exposure to the environment outside the flying craft. In contrast, external cameras and sensors are mounted to the exterior structure of a flying craft. An externally mounted camera is subject to the environment outside the flying craft at all times. The uses of both internally and externally mounted cameras and sensors include, but are not limited to, surveillance, reconnaissance, monitoring, surveying, broadcasting and capturing motion pictures.

Both internally mounted and externally mounted cameras and sensors are limited by their respective installations. The internally mounted camera has a limited field of view. The flying craft interior structure will obstruct image capturing during lateral rotation of the camera. Furthermore, interior arrangement modifications to accommodate a camera or sensor inside the body of a flying craft create a single function aircraft.

Externally installed cameras and sensors have certain limitations. Externally mounted cameras and sensors affect aerodynamic properties of the flying craft at all times. The change in aerodynamic properties, resulting from an externally mounted device, reduces flying craft performance and increases structural stress and fatigue. Furthermore, aerial cameras and sensors are expensive. Flying craft with externally mounted cameras and sensors must be parked in a secured area to prevent damage and deter theft. Under the current political environment, there is a requirement to conceal cameras and sensors from the public and/or foreign governments. The mechanized lift platform of the present invention satisfies this requirement.

What is needed is a method of aerially capturing images, sounds and data collectively or individually, by combining the functionality of the internally and externally mounted cameras. What is needed is a mechanism that can extend a camera or sensor outside the flying craft for a full field of view, and can be retracted inside the body of the aircraft upon completion of image, sound and/or datum collection to maximize the flying craft performance. What is needed is a flying craft that can be used to capture images, sounds and data and transport passengers and freight.

### SUMMARY OF THE INVENTION

It is an object of this invention to provide an improved method of aerially capturing images, sounds and data. It is an object of this invention to provide a mechanized lift platform that extends and retracts a camera or sensor, individually or collectively, from a flying craft. It is an object of this invention to provide a method to create a multi-role flying craft that is able to aerially capture images, sounds and data and efficiently transport cargo and passengers. It is yet a further objective of this invention to provide an improved method of aerial photography, video, sound collection and multimedia that is concealed from the public's view.

One aspect of this invention provides for aerially capturing images, sounds and data. A device is provided for extending a camera or sensor outside a flying craft whereby the camera or sensor can be completely retracted into the aircraft. A platform structure is used to mount a camera or sensor. An electric motor provides power. A mechanized liner motion structure stabilizes and guides the camera or sensor mounting platform during extension and retraction. Concealment doors open and close upon extension and retraction of the camera or sensor. Relay switches are routed to the flying craft cockpit or cabin to operate the lift platform and concealment doors to operate the camera or sensor during flight to collect images, sounds and data, or any combination thereof, and to retract the camera or sensor after completion of activities.

Another aspect of this invention provides for aerial photography, video, sound collection and multimedia, and transmitting said captured images, sounds and data to a graphical display. The invention thus provides for a multi-role aircraft.

Various other objects, advantages and features of this invention will become apparent to those skilled in the art from the following description in conjunction with the accompanying drawings.

### DESCRIPTION OF THE DRAWINGS

The invention will be better understood with reference to the following drawings, in which:

FIG. 1 is a perspective view of a body with a camera or sensor mechanized lift platform in a fully extended position;

FIG. 2 is a side, cross-sectional, view of the camera or sensor mounted to the mechanized lift platform, and mounting structure;

FIG. 3 is a diagrammatic elevational view of the lift platform and mounting structure;

FIG. 4 is a side perspective view of another embodiment of the lift platform and partial view of the mounting structure in the form of an installation kit;

FIG. 5 is a top view of the lift platform and installation kit, and the gear box containing the gear mechanism, the top of the slide tubes, and the top of the electric motors;

FIG. 6 is a front view of the lift platform and installation kit; and

FIG. 7 is a side view of the lift platform and installation kit.

### DETAILED DESCRIPTION

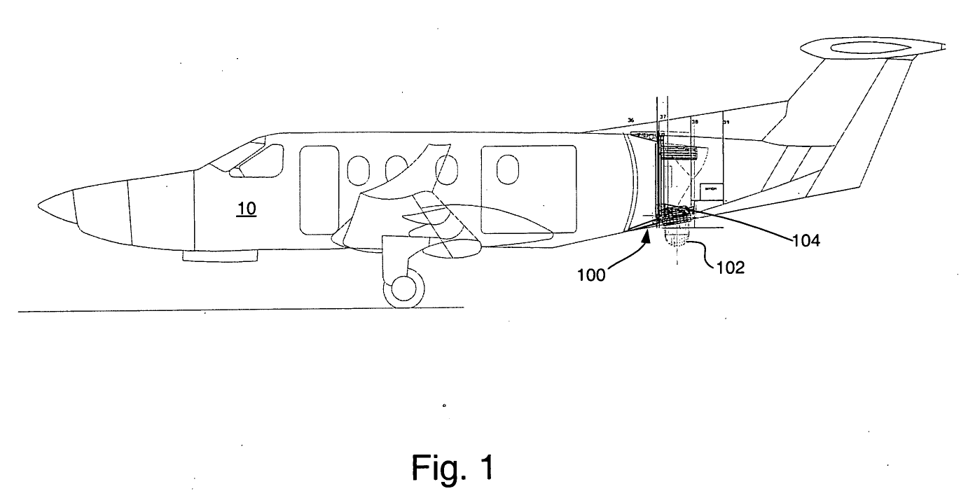

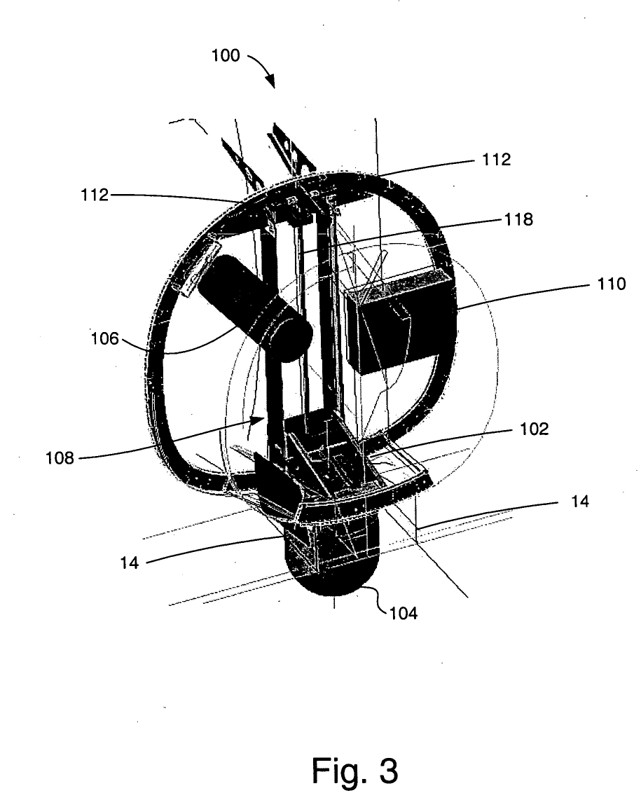

With reference to FIG. 1, a perspective view of a body, such as that of a flying craft 10, with a camera or sensor mechanized lift platform 104 in a fully extended position is shown. The mechanized lift platform 104 is for extending an object, such as a camera or sensor 102 (shown having a housing proper), individually or collectively, out of a flying craft 10, and for retracting the object back into the flying craft 10 upon completion of use. The camera or sensor 102 in the fully extended position provides a full field of view. The camera or sensor 102 is extended and retracted through concealment doors (shown in FIG. 3). The concealment doors are closed when the camera or sensor 102 are in the fully retracted position, such that the lift platform 104 and camera or sensor 102 are not subject to any outside environment, and the flying craft 10 is able to retain its original flying characteristics. A mounting structure 100 secures and guides the lift platform along a linear path for extension and retraction. The mounting structure 100 may be fitted with the fuselage of the flying craft 10, and shaped such that there is little or no intrusion of the mounting structure 100 into the interior of the craft 10. This provides for a very small effect on the cabin space in the aircraft 10 by the addition of the mounting structure 100 and lift platform 104, or no effect at all.

With reference to FIG. 3, a diagrammatic elevational view of the lift platform 104 and mounting structure 100 is shown, which illustrates individual components of the lift platform 104 and the mounting structure 100. The mechanized lift platform 104 has particular application for aerial photography, video, sound collection and multimedia. In this respect, the lift platform 104 captures images, sounds and data. The lift platform 104 provides a mechanism for extending the camera or sensor 102 outside the flying craft 10. The camera or sensor 102 can be completely retracted into the aircraft 10. The lift platform 104 comprises a platform structure on which the camera or sensor 102 is mounted.

A power source 106 is included in the mounting structure 100, which may comprise a battery, hydraulics, or electronics to utilize the aircraft's internal power. Electrically based mechanisms may power one or more electric motors 112 mounted at the top of the mounting structure 100. The electric motors 112 cause the lift platform 104 to extend and retract using a variety of systems known to those skilled in the art, such as threaded screw 118 that is turned by the electric motors 112, causing the lift platform 104 to move up and down (or in the case of a side mounted lift platform, right and left) to extend and retract the camera or sensor 102, which is mounted on the lift platform 104, outside and inside the aircraft 10. The platform 104 may further have a mechanism that inverts the camera or sensor 102 during deployment.

A linear support structure, or guide, 108 on the mounting structure 100 linearly guides the lift platform 102 and camera or sensor 102 during extension and retraction. Concealment doors 14 open and close with the extension and retraction of the camera or sensor 102. The concealment doors 14 may be mechanically linked to the lift platform 102, or drive mechanism of the lift platform, so the doors 14 are automatically opened and closed upon extension and retraction of the lift platform 104. Otherwise, the concealment doors 14 may be manually or remotely opened from the cockpit of the flying craft 10.

Relay switches (shown in a switch-box) 110 leading to the flying craft's 10 cockpit or cabin are provided to operate the lift platform 104 and concealment doors 14. As those skilled in the art would recognize, viewing and recording equipment may be connected to camera or sensor 102, while the concealment doors 14 are open and the camera or sensor 102 is extended during flight to collect images, sounds and data, or any combination thereof. Said collected images may be displayed in a live graphical display in the aircraft or to a remote site. Upon completion of camera or sensor 102 activities, the lift platform 104 retracts inside the aircraft 10. The concealment doors 14 are closed.

When the lift platform 102 is not extended, the concealment doors 14 are closed such that the original flying craft 10 speed, maneuverability and aerodynamic characteristics are not altered.

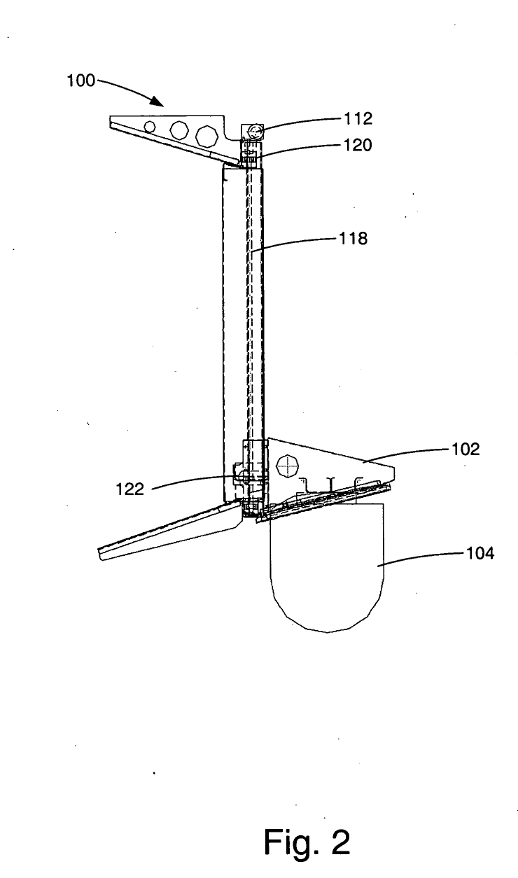

With reference to FIG. 2, a side, cross-sectional, view of the camera or sensor 102 mounted to the mechanized lift platform 102, and mounting structure 100, is shown. In this cross-sectional view, the electric motor 112, and threaded screw 118, are more clearly shown. Also shown is a gear mechanism 120 that is used to translate horizontal rotational power from the electric motor 112 to the relatively vertically-situated, threaded screw 118. Also more clearly shown is an annular engagement structure 122 that is part of, or connected to, the lift platform 102, which engages the threaded screw 118, such that when the threaded screw 118 is rotated by the electric motor 112, the lift platform 102 is extended or retracted, depending on the rotational direction applied to the threaded screw 118, by the electric motors 112. Thus, the rotation of the screw 118 is translated into linear motion by the lift platform's engagement thereto. Those skilled in the art would recognize that the engagement structure 122 may comprise a simple matching thread formed on an inside annular wall and fitted around the threaded screw 118, or a bearing, or slide bearing 406, fitted around the threaded screw 118 for smoother operation.

Alternatively, the lift platform 102 may be driven by a hydraulic system, or spring loading. Other drive mechanisms may be used, such as a magnetic or pneumatic system. Further, a clutch and break apparatus may be added to control the depth and speed of deployment and retraction of the platform.

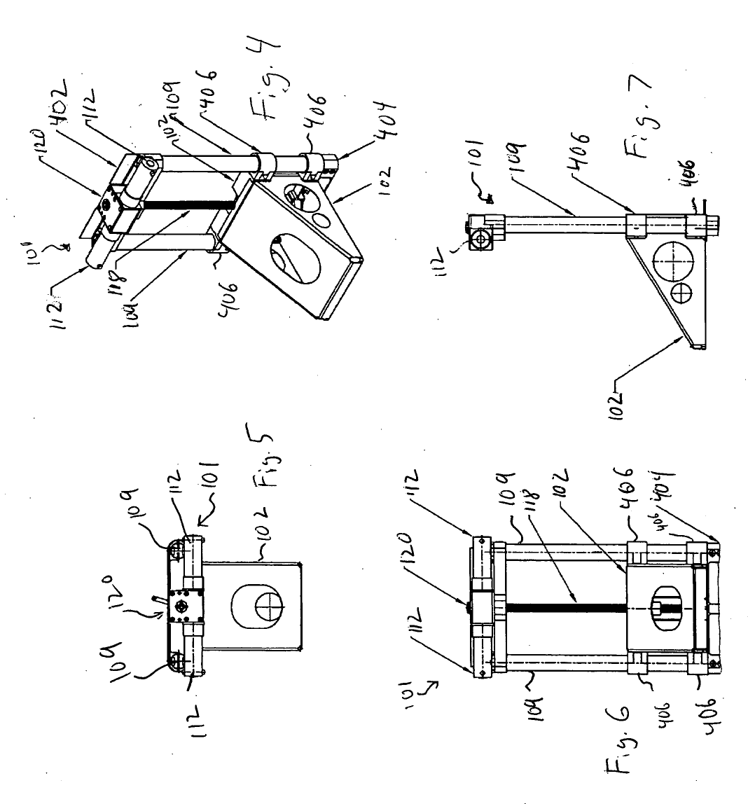

With reference to FIG. 4, a side perspective view of another embodiment of the lift platform 102 and partial view of the mounting structure 100 in the form of an installation kit 101 is shown. The installation kit 101 provides a common interface for the lift platform system that is fitted into the mounting structure 100 of FIG. 3. The embodiment of FIG. 4 also comprises a support and slide assembly that is bolted to the installation kit 101.

An upper mount 402 provides a primary interface with the installation kit 101 that is attached to the mounting structure 100 (FIG. 3) and/or the aircraft 10 frame. The upper mount 402 also provides a mounting surface for the motors 112.

Also attached to the upper mount 402 are two slide tubes 109 that linearly guide the lift platform 102 during movement. The lift platform 109 may engage the slide tubes 109 using bearings 406 attached to the lift platform 102 that surround the slide tubes 109. The slide 109 tubes may provide a more rigid structure over the guide mechanism (108 in FIG. 3) of the other embodiments.

A lower mount 404 also attaches to the installation kit 101 and the aircraft (10 in FIG. 1) frame. This lower mount 404 floats on the slide tubes 109 in order to provide strain relief should there be any flex or temperature difference in the installed system. This is to prevent any binding in the operation of the system or drive mechanism.

As explained above, the motors 112 and gear mechanism 120 cause the threaded screw 118 to turn to move the lift platform 102 linearly. This movement of the lift platform 102 can be driven with either of the two motors 112. The motors 112 directly interface with the gear mechanism 120, which comprise a gearbox assembly having an electromagnetic clutch such as one described in U.S. Pat. No. 4,679,674, or produced by Danaher Linear Motion Systems of Amherst, N.Y. The motors 112 may comprise a redundant system, one primary drive motor 112, and a secondary motor 112, providing backup in the event of a failure. The motors 112 can be used interchangeably as primary and secondary motors 112. The clutch enables one of the motors 112 to be used as the primary motor 112. The other motor 112 may be disabled, as it may be used as the secondary motor 112. The disabled motor 112 will not engage unless the clutch has been activated.

FIG. 5 is a top view of the lift platform 102 and installation kit 101. Also shown is the gear box containing the gear mechanism 120, the top of the slide tubes 109, and the top of the electric motors 112.

FIG. 6 is a front view of the lift platform 102 and installation kit 101. Also shown is the gear box containing the gear mechanism 120, the front of the slide tubes 109, the front of the bearings 406, and the front of the electric motors 112. The front of the lower mount 404 and threaded screw 118 are further shown.

FIG. 7 is a side view of the lift platform 102 and installation kit 101. Also shown is a slide tube 109, the side of an electric motor 112, and two of the bearings 406.

While there has been shown preferred embodiments of the present invention, those skilled in the art will further appreciate that the present invention may be embodied in other specific forms without departing from the spirit of central attributes thereof. All such variations and modifications are intended to be within the scope of this invention as defined by the appended claims.

1. A system for extending and retracting an sensor outside and inside an outside surface of an aircraft, comprising:
a mounting structure attached within the aircraft;
a platform to which the sensor is attached;
a linear guide comprising one or more tubes that are connected to the mounting structure, wherein the linear guide directs linear movement of the platform; and
a mechanism for extending and retracting the platform, outside and inside the aircraft, along the linear guide.

2. A system for extending and retracting an object outside and inside an outside surface of a body, comprising:
a mounting structure attached within the body;
a platform to which the object is attached;
a linear guide comprising one or more tubes that are connected to the mounting structure, wherein the linear guide directs linear movement of the platform; and
a mechanism for extending and retracting the platform, outside and inside the body, along the linear guide.

3. The system of claim 2, wherein the body is an aircraft.

4. The system of claim 2, wherein the object is a sensor.

5. The system of claim 2, wherein the object is a camera.

6. The system of claim 2, wherein the mechanism is electrically driven.

7. The system of claim 2, wherein the mechanism is hydraulically driven.

8. The system of claim 2, wherein the mechanism is magnetically driven.

9. The system of claim 2, wherein the mechanism is pneumatically driven.

10. The system of claim 2, wherein the mechanism comprises a linear motion screw.

11. The system of claim 2, wherein the mechanism comprises a clutch and brake apparatus.

12. The system of claim 2, wherein the body comprises concealment doors that are opened upon extending the object, and closed upon retracting the object.

13. The system of claim 2, wherein the mounting structure is fitted into the shape of the body so as limit intrusion into the body.

14. A method for extending and retracting an object outside and inside an outer surface of a body, comprising:
attaching the object to a platform; and
extending and retracting a platform outside and inside the body along a linear guide comprising one or more tubes that direct linear movement of the platform, the linear guide being connected to a mounting structure attached within the body.

15. The method of claim 14, wherein the body is an aircraft.

16. The method of claim 14, wherein the object is a sensor.

17. The method of claim 14, wherein the object is a camera.

18. The method of claim 14, wherein the step of extending is performed by an electrically driven mechanism.

19. The method of claim 14, wherein the step of extending is performed by a hydraulically driven mechanism.

20. The method of claim 14, wherein the step of extending is performed by a magnetically driven system.

21. The method of claim 14, wherein the step of extending is performed by a pneumatically driven system.

22. The system of claim 14, wherein the step of extending is performed using a linear motion screw.

23. The system of claim 14, wherein the step of extending is performed using a clutch and brake apparatus.
